(19) United States
(12) Patent Application Publication
(10) Pub. No.: US 2009/0106378 A1
(43) Pub. Date: Apr. 23, 2009

(54) Open System for Integrating and managing computer-based components representing a specific functionality of a specific application

(75) Inventors: Carlos Moreno, Chateau Landon (FR); Yu Liu, Ferriere (FR); Stephane Belot, Longueville (FR)

Correspondence Address: PERMAN & GREEN, 425 POST ROAD, FAIRFIELD, CT, 06824, US

(73) Assignee: SINOVIA, Evry, FR (FR)

(21) Appl. No.: 11/997,151

(22) PCT Filed: Jul. 26, 2005
(86) PCT No.: PCT/FR2005/050620

§ 371 Date: Jul. 28, 2008

(30) Foreign Application Priority Data
Jul. 26, 2005 (FR) PCT/FR2005/050620

(51) Int. Cl. G06F 15/16

(52) U.S. Cl. 709/206

(57) ABSTRACT

An open system for integrating and managing computer-based components representing a specific functionality of a specific application with a computer-based core including: a standard context for integrating computer-based components into the specific application; an integrating protocol including instantiating and loading means for indexing, selecting and assigning computer-based components to the execution of functional objectives of the specific application; connecting means for setting up connections and monitoring message flows among the computer-based components; at least one man-machine interface for enabling the connections and the message flows among the computer-based components to be monitored by a user; specific computer-based components, dedicated to the execution of specific applications.

In order to facilitate the reading of the description which follows, the following terms are explained hereinafter:
Framework=Carrier.
Cluster/Clustering=Group, Grouping.
Bootstrap=initialization, startup.
IDs=Identifier.
Wizards=Automated assistant.
Threads=Parallelized active tasks using the processor.
Snowflack=Multiple links.

The invention relates to an open environment, that will sometimes be called “Open components”, for integrating and managing computer-based components distributed within one and the same machine or between several machines connected to a network, in particular Ethernet, especially TCP/IP. It also relates to a method associated with a tool which allows developers and users to understand the principles of component-based programming and which guides them in the various steps of an implementation project.

It is recalled that a computer-based component is an autonomous and executable software entity.

The paradigm used in the invention employs the main principles of this approach which allows greater control over the development process and significant reuse. The invention rests on the fact that a component is an element of a whole and that the objective is to achieve a whole by composition as may be the case in a systemic approach. But the invention relates to a method that is complementary to the conventional methods of analysis and design since the component is elementary and relies, in this respect, on more conventional approaches which are aimed at synthesizing a software entity on the basis of a code, hence of a programming language; this may for example be an object language, which may or may not itself be distributed.

The invention relies on identifying the roles and interactions between job entities. Firstly, the roles define various kinds of entities and lead to the creation, adaptation or to the reuse of components. Secondly, the instantiation of the components makes it possible to produce in sufficient number the players necessary for realizing the functional objective in compliance with the spatial and temporal constraints. Finally, the knowledge of the various scenarios of interactions between the instances makes it possible to define the links between the players and to control the message flows.

The invention rests on a core which offers all the basic services necessary for the management of the components, their recording, their instantiation and their representation. The core also affords the communication medium between the components and manages their connections. This reduction in the services of the core to a basic minimum greatly facilitates the handling of the framework and naturally transfers the responsibility for the integration of new services to the components in the guise of jobs, be they generic or specialized.

The invention relates to an open system for integrating and managing computer-based components representing a specific functionality of a determined application. The determined application is in particular intended to ensure the operation, supervision and control of machines connected to a computer-based network of TCP/IP Ethernet type within distributed and heterogeneous industrial installations. The system comprises a computer-based core comprising:
a standard context for integrating the computer-based components into the determined application,
an integration protocol, common to the components, comprising instantiation and loading means intended to catalogue, select and assign the computer-based components to the realization of functional objectives of the determined application, and
connection means intended to establish connections and to control message flows between the computer-based components.

The system therefore makes it possible to construct determined applications easily by incorporating and by inter-connecting heterogeneous computer-based component technologies.

A certain number of components may be offered for the design of clusters, for aiding integration and debugging, adaptation components, communication components, representation components (eg: representation of curves, display of interactive plans), etc.

In a realization, the computer-based core comprises a security service making it possible to define various levels of access to the application which correspond to user rights on the system.

In a realization, the computer-based core comprises means for managing the “man-machine” interfaces for handling the distribution of the “man-machine” interface elements exported by the components.

In a realization, the system comprises a standard container usable directly to instantiate components which are then immediately active, this container ensuring cooperation between the components.

Preferably, the container comprises at least one of the following elements:
a means for integrating the components into the determined application,
a means for hosting the “man-machine” interfaces, such as window, menu, toolbar, and statusbar,
a means for connecting the components and,
a means for persistence of the application configuration.

In a realization, the determined application is intended to ensure the operation, supervision and control of machines connected to a computer-based network, and the system comprises means for locating the set of machines having available a container with active components, and means for ascertaining the set of instances of components and their plugs. In this case, the system can comprise means such that the connections between plugs are realizable from any machine.

In a realization, the system comprises at least one “man-machine” interface generating a graphical representation of the computer-based components and intended to allow a user to control the connections and the message flows between the computer-based components.

In a realization, the system comprises specific computer-based components, dedicated to the realization of specific applications, in particular computer-based routing components making it possible to translate and to forward messages between two computer-based components, and component simulator computer-based components intended to allow a partial validation of the determined application.

In the latter case, the system can comprise computer-based routing components with means for defining the interface between the requirements expressed explicitly through requests, or implicitly by the notification of information, and for defining the various services offered by a set of grouped components. The system can also be such that component simulator computer-based components comprise a stimulator with means for writing scripts defining various message sequences intended to stimulate a particular component.

In a realization, the system comprises, for the construction of applications, composition means for interconnecting existing components according to a gluing scheme.

The gluing can be direct, the components being connected directly to each other. It can also be of the indirect type with the aid of component groupings.

Other characteristics and advantages of the invention will be apparent with the nonlimiting description of some of its embodiments, said description being given with reference to the appended drawings in which:

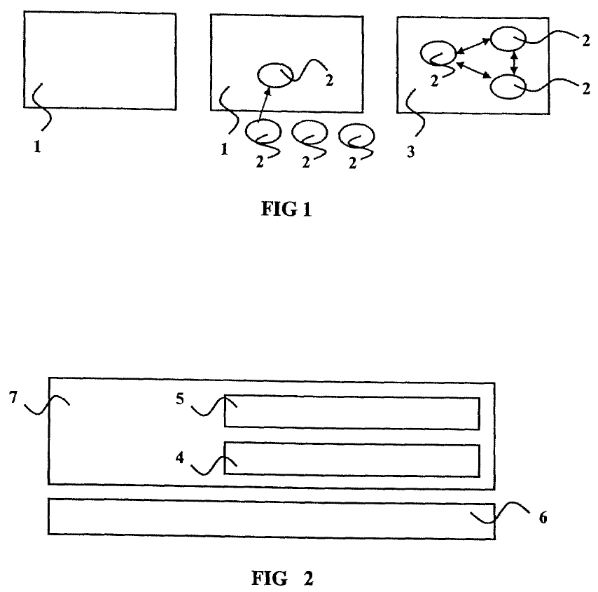

FIG. 1 represents in a schematic manner the creation of an application by assembling components,

FIG. 2 represents the general architecture of a component,

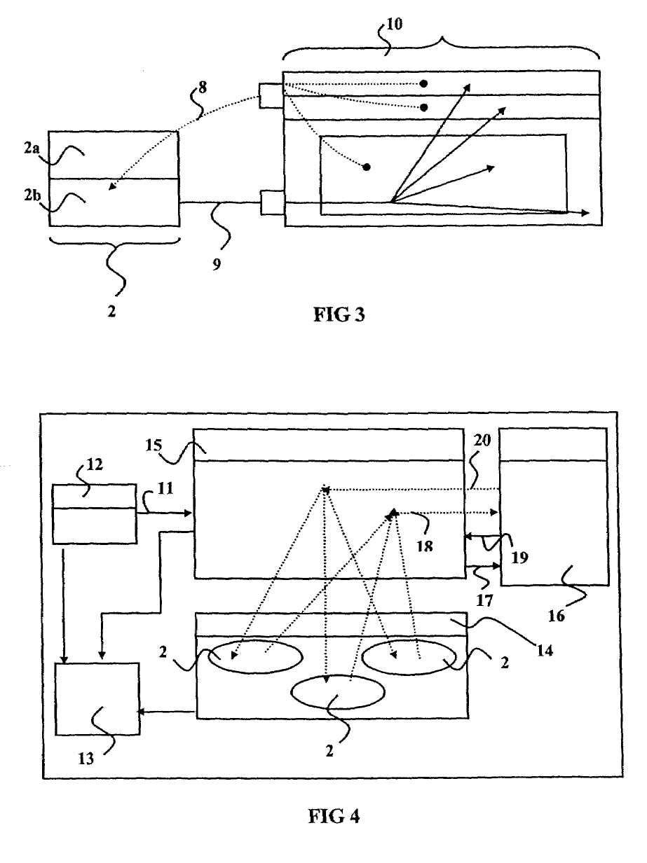

FIG. 3 illustrates the principle of integrating a component,

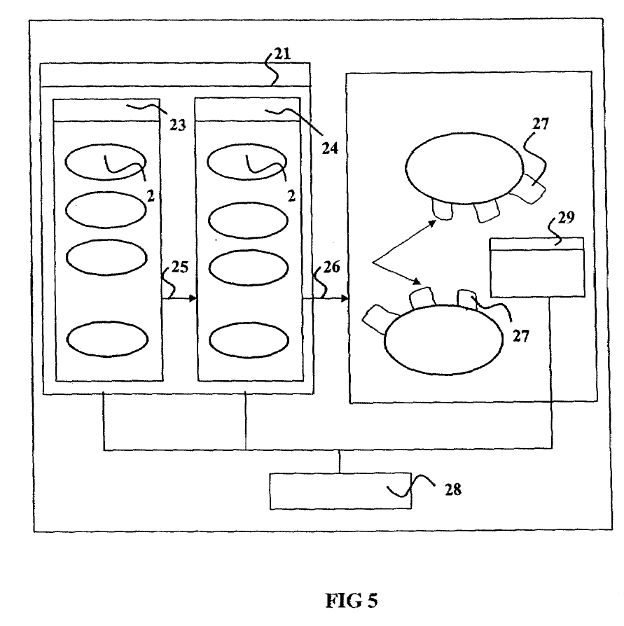

FIG. 4 represents the global architecture of the core,

FIG. 5 represents the components integration service, and

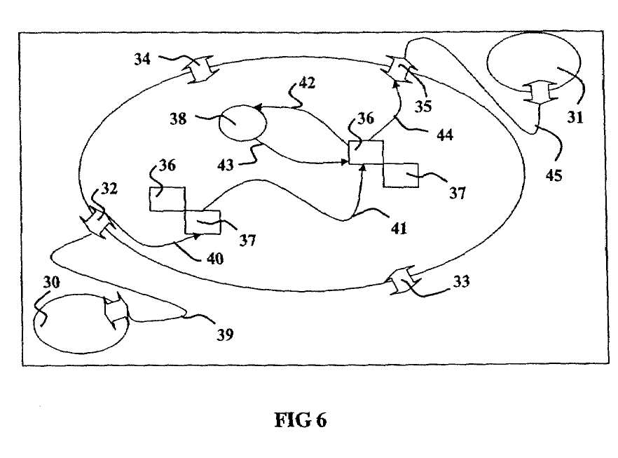

FIG. 6 illustrates the operation of a component.

### PRESENTATION

### The Core and its Services

A computer-based application always consists of functional modules which cooperate together to carry out one or more functionalities that are more complex and more sophisticated than those carried out by each of the participating modules. Moreover, different configurations of these same modules can give rise to variants of one and the same application.

The technology according to the invention consists in integrating software components each representing a specific functionality into a federator environment (the components container) and in establishing the communication between these components so as to obtain an overall behavior which meets the specification of the application.

For this purpose, the core provides the following services:
a context making it possible to integrate components and to ensure their proper operation;
a protocol which allows the integration of the components;
a means of communication between these components.

FIG. 1 represents in a schematic manner the creation of an application by assembling components. This creation is obtained through the use of a container 1 making it possible to integrate components 2 according to a determined protocol by virtue of which the components 2 will communicate with one another according to the specifications of a determined application 3.

Furthermore, the core provides two additional services of security and management of MMIs (man/machine interfaces). The security service makes it possible to define various levels of access to the application which correspond to user rights on the system. The service for managing the MMIs handles the distribution of the MMI elements exported by the components within the container application.

The set of services offered by the core is summarized in the following list:
security,
management of MMIs,
configuration of the applications,
integration of components,
external communications,

The Components

A component is an autonomous code which interacts with a given environment consisting of the container in which it is instantiated and of the whole set of other components (local and remote).

A component consists of four parts:
An integration part;
An MMI part (window(s), menu(s), toolbar and statusbar);
A “process” part which ensures the functionality of the component;
A communication part.

The integration part allows the component to integrate itself into a container application. It also allows the component to insert its MMI into the main interface of the container application. This is a standard mechanism that each component absolutely must include. A component has its own MMI for its presentation and its interaction with the user (a menu, a toolbar, one or more windows, a statusbar). A part of its MMI can be exported to the container.

The process part is an internal, behavioral level which characterizes the component's job processes.

The communication part defines an interface between the behavioral level and its environment (in particular the other components). The communicational level is itself divided into two layers: a language layer and a media layer.

FIG. 2 represents the general architecture of a component comprising a communicational level 7 itself comprising a language layer 4 and a media layer 5, and a behavioral level 6. The language layer 4 defines the communication logic interface; it depends rigorously on the job. In this respect it introduces a set of specific words, or indeed even also a particular syntax. From a general point of view the language defines the semantic framework of the various requisitions which are accepted by the component and which trigger its behaviors. Therefore, the invention is not related to any particular language but the positioning of this layer must be designed first and foremost in compliance with its relationship to the job so as to guarantee that the developments of the components are as independent as possible. The integration and interrelation of the components is then a higher level composition expedient whose objective is the implementation of several job entities for the realization of a common objective. In the description hereinafter of clustering, this aspect will be developed and a suitable technical response will be afforded.

Above the language layer which interprets the outside requisitions, the media layer 5 ensures the connectivity of the component with one or more other components and the forwarding of the data on these connections. For this purpose a component can have one or more connection terminals, called “plugs”, that can be linked together by bidirectional links. A plug is a connection terminal through which a component can transmit packets of bytes of variable length. These packets are generally the serialized form of a structured datum (a simple type, a structure or a class), of a file, etc.

The Container Application

The invention provides in the core a standard and unique container directly usable to instantiate components which are then immediately active. It plays a federator role for ensuring cooperation between the components and proposes the following services:
integration of components into the application;
hosting of MMIs: windows, menus, toolbars and statusbars;
connection of components;
persistence of the application configuration.

The integration service is central since it ensures the loading and initialization of the components, their connection brings about the activation of the other services, in particular the MMI hosting service. Its role is therefore equivalent to that of an application “bootstrap” which guarantees the search for and the installing of the components within the container.

The role of the MMI hosting service is to guarantee the interactivity between the user and the various components of the graphical environment. The interaction elements (eg: the buttons of the toolbar, the menus, etc.) are initialized at the time the components are integrated into the environment. For this purpose, this service defines an interface which allows:
the positioning of graphical components,
the importation of toolbar buttons,
the importation of menus,
a minimum display,
the contextual reallocation of keyboard events.

The definition of a screen, tied to a given application profile, can be realized during the execution of the application (with the aid of the mouse) and can be tied to the global applicative persistence. Access to this functionality, which allows the positioning of the graphical components, depends on the rights accorded to the user.

The importation of the toolbar buttons and menus of the various components is carried out automatically and leads to their disposition in the main window of the container. This window also makes it possible to access a minimum display which affords access to a certain number of basic functionalities such as the selection of a configuration.

Represented in FIG. 3, which illustrates the principle of integrating a component, are the following elements: component 2, interface 2a, process 2b, MMI data 9, MMI events 8, container 10.

A “browser” makes it possible to view the various connection terminals (the plugs) exported by each component and to connect these plugs together. The plugs browser makes it possible to obtain a complete mapping of the project which affords the designer a synthetic picture of the application and of the various communication links.

The application configuration consists of the definition of the profile of the application. This profile, persistent, is characterized by the parametrization of the graphical components (positioning and dimensioning) and the parametrization of the connections between the components.

Architecture

The Core

The application as a whole is composed of a main graphical interface, a container (the core) and components loaded by the core. The main graphical interface constitutes the home window of the application as a whole during execution. Resting on the core, it hosts the windows, the menus, the toolbars and the statusbars which belong to the core and to the integrated components.

The core provides the following services:
Components integration service
MMI service
Security service
Communication service

Represented in FIG. 4, which represents the global architecture of the core, are the following elements: components 2, the access rights 11, the security service 12, the persistence of the core 13, the components integration service 14, the MMI service 15, the MMI of the application 16, the MMI data of the core 17, the MMI data of the components 18, the commands of the core 19, the commands of the components 20.

Within the core, the integration service 14 takes charge of managing the components: their loading, their instantiation, their interconnection and the persistence of their configuration.

The MMI service 15 handles the exportation and maintenance of the graphical interface of each component in the main graphical interface of the application. It guarantees the forwarding of the events originating from the graphical interface of each component to the component itself. This service also manages the graphical and interactive objects of the core. The associated events are redistributed to the services concerned.

The security service 12 defines the level of access rights of the current session. This information is taken into account by the MMI service 15 to determine the type of the corresponding interface to be used.

The core 13 manages a database for its own persistence. Specifically, each service uses the same base to ensure its persistence, and the core plays the role of conductor for the persistence of the whole.

In what follows, the architecture of each service is described in a more detailed manner.

The Integration Service 14

The integration service manages all the operations relating to:
the loading and instantiation of the components,
the interconnection of the components,
the selection of the components,
the persistence of the configuration of the components.

The components loading, instantiation and selection operations are ensured by the components manager. Moreover, the operations relating to the interconnection of the components are managed by the communication manager described further on. Each manager handles its own persistence, and the service itself guarantees the consistency of the persistence overall.

Represented in FIG. 5, which represents the components integration service, are the following elements: management of components 21, management of connections 22, list of classes 23, list of instances 24, components 2, loading and instantiation 25, selection of instances 26, plugs 27, persistence 28, list of connections 29.

The components manager 21 maintains a list of component classes and a list of component instances. The list of classes 23 contains the descriptive information and the locality (the location) of the recorded components. The list of instances contains the instances of components being executed. The persistent form of the list of classes is called the “components register”, every component having to be recorded by the manager in the register before it can be instantiated.

For each class, the register stores the following information:
the name of the class
the version of the class
the locality of the software
other information descriptive of the class (author, “copyright”, description, etc.)

A class is identified by its name and its version. Consequently, the components of the same type but of different versions are treated as different classes. The manager creates component instances on the basis of the information obtained from the components register. The instances are named and their name is unique in the list of instances. In this way, an instance can be identified by its name in an application. For each instance stored in the list of instances, a data structure which stores its context (information associated with the instance and utilized by other services) is maintained.

The connections manager implements various services which allow the management of the plugs defined by each component at the local application level up to the global network level. These services are used in particular by the browser to locate the set of machines having an active OpenComponents container. For each container, the connections manager is then able to ascertain the set of instances of components and their plugs. The connections between plugs can be carried out from any machine whatsoever.

The MMI Hosting Service

The MMI hosting service handles first of all the management and display of the graphical and interactive objects of the core in the main interface of the application according to the right of access provided by the security service. The interaction events intended for the various services of the core are redistributed to their addressee.

The MMI hosting service creates the menus according to the access rights accorded to the current session. These menus are inserted into the main interface of the application. The service takes charge of the redistribution of the commands of these menus to the various services of the core.

Since the components are independent software units (eg: DLL in the Windows environment), the identifiers of commands used by a component may be redundant when several components are situated in one and the same execution space. A substitution of the command identifiers and of the window identifiers is necessary to properly distinguish the graphical objects and the command identifiers in the main interface of the application. A lookup table for the windows handles the substitution of the window identifier in respect of each window that a component wishes to insert in the guise of daughter window into the main interface. In the same manner, a lookup table for the command identifiers monitors the substitution of the command identifiers in the menus and the toolbars of a component that are inserted into the main interface. The correspondence between the IDs (identifiers) of the application and the original IDs is retained and verified before the redistribution of the commands to the addressee component so that the latter always uses the original IDs inside its code.

Creation of Components

Creation

The “OpenComponents” SDK (library) makes it possible to create its own components. It comprises the whole set of standard OpenComponents libraries affording access in particular to the various services of the core. Wizards corresponding to different patterns of components (components furnished with an MMI, threaded components, persistent components, etc.) facilitate design and guide the programmer in his handling of the core.

Various examples of components illustrate the fundamental principles of the invention. Other examples show the degree of complexity that it is possible to achieve with a development process that is greatly simplified by the componential paradigm which is naturally incremental and therefore more easily mastered than a conventional monolithic development.

Unit Tests and Validation

Before integrating a new component it is important to test it. At this moment the component is viewed as a “black box” and may undergo tests aimed at validating its various behaviors.

A test consists of a particular scenario of stimulations whose possible responses have been anticipated. Comparative analysis of the actual responses of the component makes it possible to verify its behavior in relation to external requisitions.

The “Messenger” Component

Messenger is a component which allows the fine-tuning of components. It is a stimulator in which it is possible to write scripts which define various sequences of messages intended to stimulate a particular component. Each script corresponds to a test scenario, the execution of the scenario making it possible to validate or otherwise the behaviors of the component.

Construction of Applications

Composition

The construction of an application is an act of composition which consists in interconnecting existing components according to a particular gluing scheme. This scheme constitutes a grouping of different skills which can interact to produce a particular organization that can be likened to a distributed virtual application. Two gluing techniques exist: direct gluing and indirect gluing.

Direct gluing consists in connecting two components directly. This technique presents the advantage of not requiring any intermediate processing but poses the problem of the independence of the components. It assumes indeed that the two components use the same language. However no connections exist other than the connections between components. To manage this problem, the invention introduces the concepts of reactive components and cognitive components.

A reactive component is a component capable of little initiative and endowed with very limited knowledge. This type of component is generally controlled by higher level components, viz. the cognitive components.

A cognitive component is a component capable of initiatives and endowed with knowledge which may be upgradable. These components are generally controlling entities which centralize a certain number of services rendered by reactive components. The mediators used in indirect gluing are components of cognitive type.

Indirect gluing consists in connecting a set of components to one and the same central component which then serves them as mediator. This technique presents many advantages, including a methodological advantage with respect to the conventional development processes.

Functional “Clustering”

From a general point of view an application is an arbitrary graph whose nodes are instances of components and whose links are the connections between these instances. This graph is constructed directly in the main window which offers by default the functionalities for creating and connecting the components. It can be saved in the form of a configuration file whose name is generally that of the application.

A functional cluster, or cluster (that may be regarded as an application), is a particular group of components, or functional entities, linked together by way of a routing component named the “Cluster Manager”. This component, which knows the set of services offered by each functional entity, effects the interface between the requirements expressed, explicitly by requests or implicitly through notifications of information, by these entities and the services offered by the others. Each entity linked to the router is an acquaintance of the router. The graph of the application is a star graph. However this graph can be increased by the interconnecting of clusters and then constitute an architecture of “snowflack” type.

The interconnection of clusters allows enhanced management of the applicative complexity in terms of functional and geographical distribution in a hierarchy whose base consists of (highly reactive) elementary components and whose vertex requires the implementation of high-level components that are generally involved in a decision process based on the manipulation of synthesis data.

Another benefit of this architecture is that it makes it possible to isolate each of the functional entities and to limit the phenomena whereby the job of one intrudes into the job of the other (which phenomena generally entail strong interdependencies and give rise to shared code).

Creation and Fine-Tuning of Clusters

Among the various generic components that can be appended to the “OpenComponents” framework, a component called “Maestro” allows the construction and development of clusters. The manager of a cluster is called the “cluster manager” (or router).

Maestro makes it possible to define the interface between requirements expressed explicitly through requests or implicitly by the notification of information and the various services offered by the set of components of the cluster (its acquaintances). This interface is a router of messages for which the user can define various translators. Maestro makes it possible to define, for each acquaintance, its links with the other acquaintances and, for each link, the translators which interpret and translate the messages.

Represented in FIG. 6, which represents the operation of the generic component Maestro, are the following elements: component A 30, component B 31, acquaintance A4 32, acquaintance A1 34, acquaintance A3 33, acquaintance A2 35, Ae1 36, Ar1 37, translator T2 38. The various arrows represent the following events:

Arrow 39: Dispatching of a message from component A to acquaintance A4 of the router.

Arrow 40: Notification of the receipt of a message originating from an acquaintance.

Arrow 41: Routing of the message to the tied acquaintance or acquaintances.

Arrow 42: Dispatching of the message to the translator.

Arrow 43: Translation of the message.

Arrow 44: Recovery of the communication port.

Arrow 45: Sending of the translated message to the component.

This relationship between the requirements (or information) and the services expresses a dynamic defined entirely at the router level and which characterizes an application in a unique manner.

Apart from a component's specific bugs, a cluster may have an unforeseen behavior generally related to poorly defined routing. It may then be necessary to track the message flows managed by the cluster manager by defining stopping points. For this purpose Maestro makes it possible to track in real time the execution of a cluster and allows the step-by-step tracking of the various message flows.

Partial Validation of a Cluster

Component-based programming is an iterative process which, to be as effective as possible, must also integrate the concept of partial validation. Thus, even if the components are not yet all realized, it will be possible for the components which were validated during the unit tests to be partially tested in an interaction context close to the final context.

The partial validation of a cluster therefore consists in studying the general behavior of a part of an application, or of a subset of its components. However, it may be necessary to simulate certain messages so as to allow the triggering of a process that one desires to validate. For this purpose a component simulator component “Virtual Components” is proposed for substituting itself for a component on standby awaiting integration. This substitution remains partial insofar as the simulator cannot implement the actual behaviors of the simulated component but makes it possible to respond to certain messages in a mechanical manner through a script.

Interoperability

An Open Environment

“OpenComponents” is an environment open to most current component technologies. This openness is obtained on the basis of an interface adaptation mechanism which makes it possible to incorporate various types of component technologies and to render these technologies interoperable with the whole set of other components managed by “OpenComponents”.

The Skins

A “skin” is an adaptation interface which translates the messages entering and exiting a component that are expressed in the native language of its interface. The skins therefore make it possible to ensure interoperability of the OpenComponents components with other components arising from different technologies.

Global Plug&Net

Hardware and Software Components

“OpenComponents” can be inserted into a complete range of products aimed at the command-control of distributed and heterogeneous installations. The invention allows the simple and fast implementation of supervision and control modules distributed between hardware agents and software components on networks of various types from terrain networks in conjunction with terminal equipment (automatons or inputs/outputs) up to WAN networks.

1. An open system for integrating and managing computer-based components representing a specific functionality of a determined application, this determined application being in particular intended to ensure the operation, supervision and control of machines connected to a computer-based network of TCP/IP Ethernet type within distributed and heterogeneous industrial installations, this system comprising a computer-based core comprising:
a standard context for integrating the computer-based components into the determined application,
an integration protocol, common to the components, comprising instantiation and loading means intended to catalogue, select and assign the computer-based components to the realization of functional objectives of the determined application, and
connection means intended to establish connections and to control message flows between the computer-based components.

2. The system as claimed in claim 1 in which the computer-based core comprises a security service making it possible to define various levels of access to the application which correspond to user rights on the system.

3. The system as claimed in claim 1 in which the computer-based core comprises means for managing the “man-machine” interfaces for handling the distribution of the “man-machine” interface elements exported by the components.

4. The system as claimed in claim 1 comprising a standard container usable directly to instantiate components which are then immediately active, this container ensuring cooperation between the components.

5. The system as claimed in claim 4 in which the container comprises at least one of the following elements:
a means for integrating the components into the determined application,
a means for hosting the “man-machine” interfaces, such as window, menu, toolbar, and statusbar,
a means for connecting the components and,
a means for persistence of the application configuration.

6. The system as claimed in claim 4 in which the determined application is intended to ensure the operation, supervision and control of machines connected to a computer-based network, and the system comprises:
means for locating the set of machines having available a container with active components, and,
means for ascertaining the set of instances of components and their plugs.

7. The system as claimed in claim 6 comprising means such that the connections between plugs are realizable from any machine.

8. The system as claimed in claim 1 comprising at least one “man-machine” interface generating a graphical representation of the computer-based components and intended to allow a user to control the connections and the message flows between the computer-based components.

9. The system as claimed in claim 1 comprising specific computer-based components, dedicated to the realization of specific applications, in particular computer-based routing components making it possible to translate and to forward messages between two computer-based components, and component simulator computer-based components intended to allow a partial validation of the determined application.

10. The system as claimed in claim 9 comprising computer-based routing components with means for defining the interface between the requirements expressed explicitly through requests, or implicitly by the notification of information, and for defining the various services offered by a set of grouped components.

11. The system as claimed in claim 9 in which component simulator computer-based components comprise a stimulator with means for writing scripts defining various message sequences intended to stimulate a particular component.

12. The system as claimed in claim 1 comprising, for the construction of applications, composition means for interconnecting existing components according to a gluing scheme.

13. The system as claimed in claim 12 in which the gluing is direct, the components being connected directly to each other.

14. The system as claimed in claim 12 in which the gluing is of the indirect type with the aid of component groupings.
